(19) United States
(12) Patent Application Publication
(10) Pub. No.: US 2009/0190363 A1
(43) Pub. Date: Jul. 30, 2009

(54) Plant grow light with digital timer

(76) Inventors: Joseph McDonnell, Miramar, FL (US); Julie McDonnell, Miramar, FL (US)

Correspondence Address: HARNESS, DICKEY & PIERCE, P.L.C., P.O. BOX 8910, RESTON, VA, 20195, US

(21) Appl. No.: 12/010,669

(22) Filed: Jan. 29, 2008

(51) Int. Cl. F21V 21/14; F21S 8/00

(52) U.S. Cl. 362/396; 362/419

(57) ABSTRACT

A plant grow light attachable to a plant pot that includes a digital timer having a plurality of preset timing positions to cycle the plant grow light on and off according to a desired lighting cycle for a particular plant.

### FIELD OF THE INVENTION

The present invention relates to a plant grow light and digital timer. More particularly, the present invention relates to a plant grow light that is attachable to a plant pot and the digital timer to control an amount of exposure to light for a desired plant.

### BACKGROUND OF THE INVENTION

Indoor gardening often requires artificial lighting to stimulate and maintain proper plant growth. By using the proper lighting conditions plants, flowers, fruits & vegetables may be grown indoors year round. The lighting requirements may be provided for by artificial, rather than natural, light by using a plant grow light. However, lighting requirements may vary greatly depending the age genus and/or species of the plant. For example, some plants do well with up to 12 hours of light a day, while other plants may require up to 16 hours of light per day.

Additionally, depending on the frequency and wattage of a lamp in the plant grow light, the position of the lamp relative to the plant may need to be adjustable. For example, higher wattage lights put out more heat and, therefore, may need to be positioned such that the plant will not become stressed or burn. A 1000 watt lamp may over heat or stress some plants if closer than 2 feet, while other plants may not be stressed by the heat and intensity of light from such a bulb. Also, depending on a surface area of a plant, the area the lamp may need to cover may be different or change over time. If a larger coverage area is needed then the lamp is positioned farther from the plant to increase the coverage area and if less coverage area is needed then the lamp is be positioned closer to the plant. However, such changes in lamp position may stress a plant due to an increase in heat and light intensity.

Most grow lights are suspended from a frame or a ceiling in a fixed position. To control light intensity exposure and/or coverage area, a plant position is raised or lowered relative to the grow light by being placed on or off of a platform. To control proper exposure to light, a user must manually turn the grow light on and off. Due to variations in the exposure duration caused by failure to timely turn the grow light on or off, the plant may be stressed due to over exposure to light and/or heat.

### SUMMARY OF THE INVENTION

In accordance with the present invention, a plant grow light may be attachable to a plant pot and include a digital timer having a plurality preset timing positions to cycle the plant grow light on an off according to a desired lighting cycle for a particular plant.

In an example embodiment, the plant grow light may include a flexible coil, a clip attached to a first end of the flexible coil, a lamp attached to a second end of the flexible coil and a digital timer attached to the plant grow light that controls activation of the lamp.

In an example embodiment, the digital timer may include a semiconductor device that controls a lighting cycle of the plant grow light. An output of the semiconductor device may be operably connected to the lamp.

In an example embodiment, the semiconductor device may include at least one memory device that stores a program for calculating a clock cycle corresponding to a lighting cycle of the plant grow light.

In an example embodiment, the semiconductor device may include at least one memory device that stores at least one program for calculating a clock cycle corresponding to a lighting cycle of a plurality of different plant types. The semiconductor device may also control a predetermined lighting cycle for a plurality of different plant types.

In an example embodiment, the digital timer is attached to the flexible coil. The flexible coil may include a flexible core that may be covered by an outer layer.

In an example embodiment the plant grow light may also include a socket that receives the lamp and is attached to the flexible coil. The lamp may include at least one light bulb and have a light shield disposed over a surface of the at least one bulb. The light shield may have a reflective material on an inner surface to reflect light from the at least one bulb away from the light shield.

Other advantages and objects of the present invention will become apparent to those skilled in the art from the subsequent detailed description, appended claims and drawings.

### BRIEF DESCRIPTION OF THE DRAWINGS

The present invention will become more fully understood from the detailed description given below and the accompanying drawings, which are given for purposes of illustration only and thus, do not limit the invention. In the drawings which illustrate the best mode presently contemplated for carrying out the present invention:

FIG. 1 is a perspective view of a plant grow light and digital timer in accordance with an embodiment of the present invention;

FIG. 2 is a view of a timer in accordance with an embodiment of the present invention;

FIG. 3 is a schematic view of a digital timer according to an embodiment of the present invention;

FIG. 4 is a perspective view of a plant grow light and flexible coil in accordance with an embodiment of the present invention; and

FIG. 5 is a bottom view of an example of a lamp in accordance with an embodiment of the present invention.

### DETAILED DESCRIPTION OF THE EXEMPLARY EMBODIMENTS

Referring now to the drawings in which like reference numerals designate like or corresponding parts throughout the several views, there is shown an example embodiment of a plant grow light and digital timer, shown merely for the purpose of illustration. One skilled in the art will readily recognize from the following description, taken in conjunction with the accompanying drawings and claims, that the principles of the present invention may be applicable to other embodiments other than that shown for purposes of illustration in the drawings.

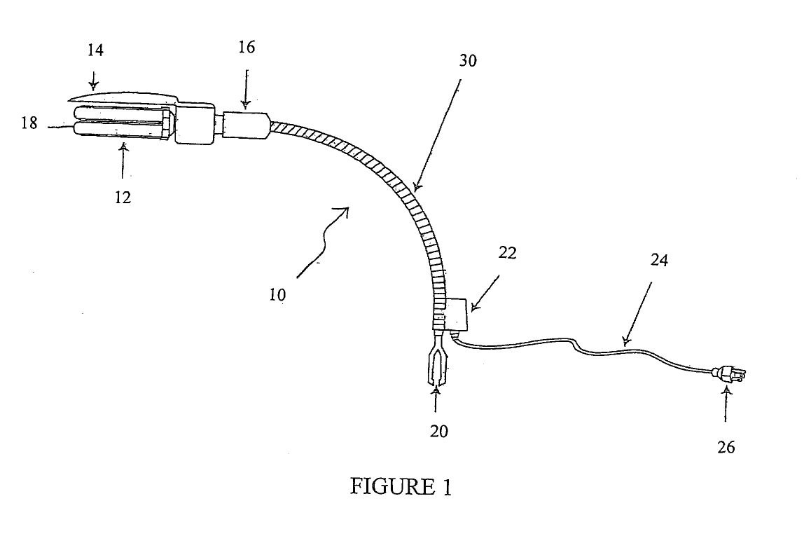

As shown in FIG. 1 a plant grow light 10 may include a clip 20 to attach the grow light 10 to a plant pot (not shown). A flexible coil 30 may extend from the clip 20 and have a lamp 12 disposed at an end of the flexible coil 30 opposite the clip 20. The lamp 12 is attachable to the flexible coil 30 via a socket 16. The lamp 12 may include one or more bulbs 18 and a light shield 14 disposed over a surface of the bulbs 18. A timer, such as a digital timer 22 may be attached to the flexible coil 30 and include a power cord 24 having a plug 26. The plug 26 is insertable into an electrical outlet to power the lamp 12 and the digital timer 22.

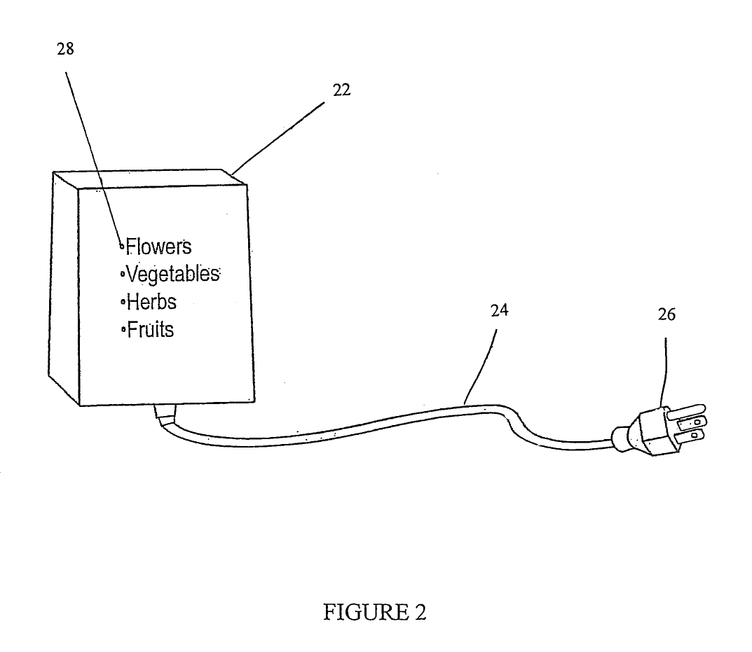

As shown in FIG. 2, the digital timer 22 may include one or more selectable preset timer positions 28 that correspond to a particular light exposure cycle for a plant. In an example embodiment, the digital timer 22 may include preset timer positions 28 for flowers, vegetables, herbs and fruits. A desired timer position may be selected by operatively activating a switch, button, or the like corresponding to the desired preset timer position.

The digital timer 22 may include one or more selectable timer inputs 28 that correspond to an amount of light exposure for a desired plant. Although flowers, vegetables, herbs and fruits are shown in FIG. 2 as being plants having a corresponding preset timer input 28, the digital timer is not limited to only these plant-types or number of preset timer positions. The digital timer 22 may also include, for example, preset timer positions for other plant-types or species of plants. Moreover, in an embodiment, the digital timer may include preset positions for stages of plant growth which require varying amounts of light exposure. For example, a plant in a seed stage may require longer light exposure to cause germination.

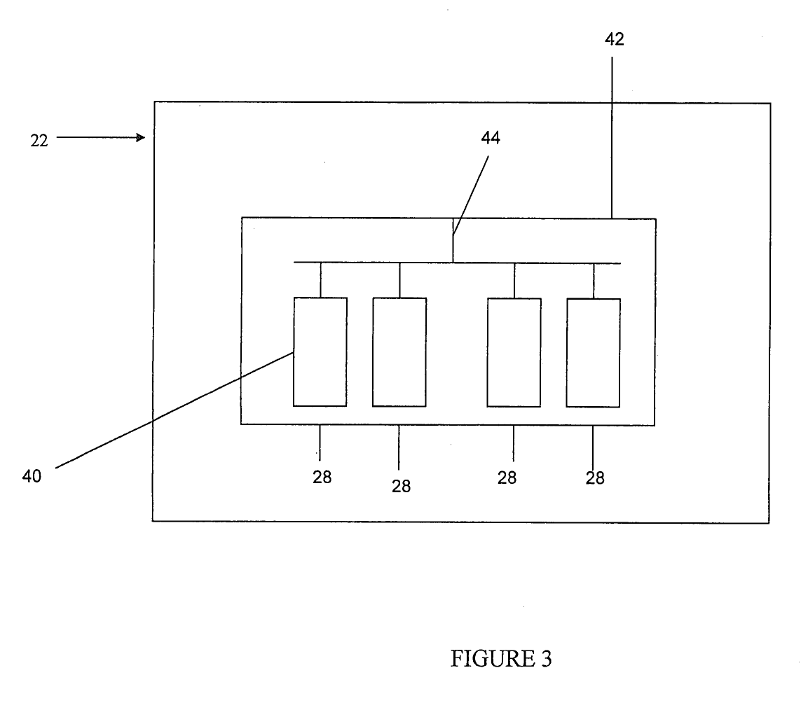

As shown in the schematic view of a digital timer 22 according to an exemplary embodiment of the present invention in FIG. 3, the digital timer 22 may also include one or more memory devices 40 disposed, for example, in a semiconductor device 42. The memory device may include, for example, a timer or clock corresponding to a known optimum light exposure cycle for a plant designated at each timer input position.

In an embodiment, selecting a selectable timer input 28 may turn the lamp 12 on and activate a program stored within a corresponding memory device 40. The stored program may be a clock that counts up or counts down for a time period according to the stored program. Once the program has run and the clock has reached an end, a signal is sent via the output 44 that is operably connected to the socket 16 to turn the lamp 12 off. The stored program may also repeat the exposure cycle. In an example embodiment, the selected exposure cycle may continue until a different preset is selected.

In operation, a user may attach the grow light 10 to a pot (not shown) containing flowers, vegetables, herbs or fruits, using the clip 20. In an example embodiment, the clip 20 may be a bifurcated metal or plastic, for example, that receives an edge wall of a pot. Although the clip 20 is shown as having the configuration in FIG. 1, other type clips are within the scope of the present invention. For example, the clip 20 may be a spring-type clip. The clip may have serrated edges, or a non-slip surface to enhance the grip to the pot.

Once the grow light 10 is secured to a pot by the clip 20, the grow light 20 may be positioned by altering a configuration of the flexible coil 30 to place the lamp 12 at a desired position. For example, depending on the frequency and wattage of the light bulb 18 in the lamp 12 and the type of plant in the pot, the lamp may need to be moved closer or farther from the plant by altering a position of the flexible coil 30. Similarly, the flexible coil 30 may be configured to properly position the lamp 12 as the plant grows or a surface of the plant otherwise changes.

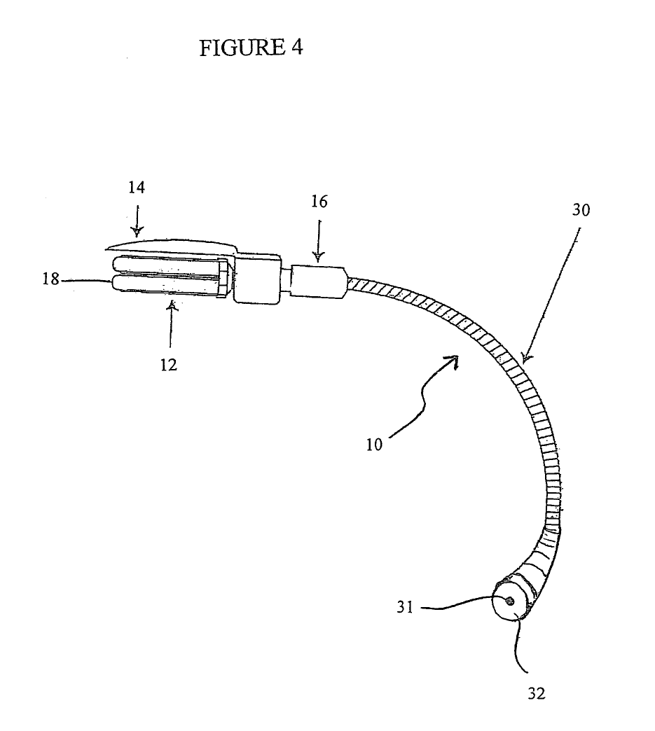

As shown in FIG. 4, in an example embodiment, the flexible coil may include a flexible core 31. The core 31 may be wrapped or encased by an outer flexible wrapping 32. The core 31 and the wrapping 32 may be comprised of a metal or synthetic material. In an alternative embodiment, the flexible coil 30 may be a plurality of jointed, articulated sections that allow for flexible positioning of the grow light 10.

Upon positioning the flexible coil 30 and lamp 12 at a desired position, a user may select a desired light exposure scheme according to the type of plant in the pot. For example, if the plant is a flower, the user may select a timer input 28 corresponding to a flower or other plant. Selection of the timer input 28 activates a stored program in a corresponding memory device 40 in a semiconductor device 42 of the digital timer 22 that provides a predetermined optimum light cycle for the flower or other plant. In an example embodiment, selection of the timer input may simultaneously turn the lamp 12 on and activate the stored program. The stored program includes a clock that counts for a preset ON period. While the clock is running, the lamp remains on and the flower is lighted. At the end of the clock period, a signal is sent from the semiconductor device 42 via the output 44 to turn the lamp off for a preset OFF period. Upon completion of the OFF period, an ON signal will be sent from the semiconductor device 42 to the lamp to light the flower for the optimum period.

In an embodiment, the stored program may include an internal timer to turn the lamp on and off according to a preset timetable. For example, upon activation of a timer input 28, the lamp may be turned on. The lamp may remain on during a clock counting cycle and then be turned off at the end of the clock counting cycle. The lamp may then be turned on again according to an off period. The on/off cycle may continue according to a preset period stored in the memory device 40.

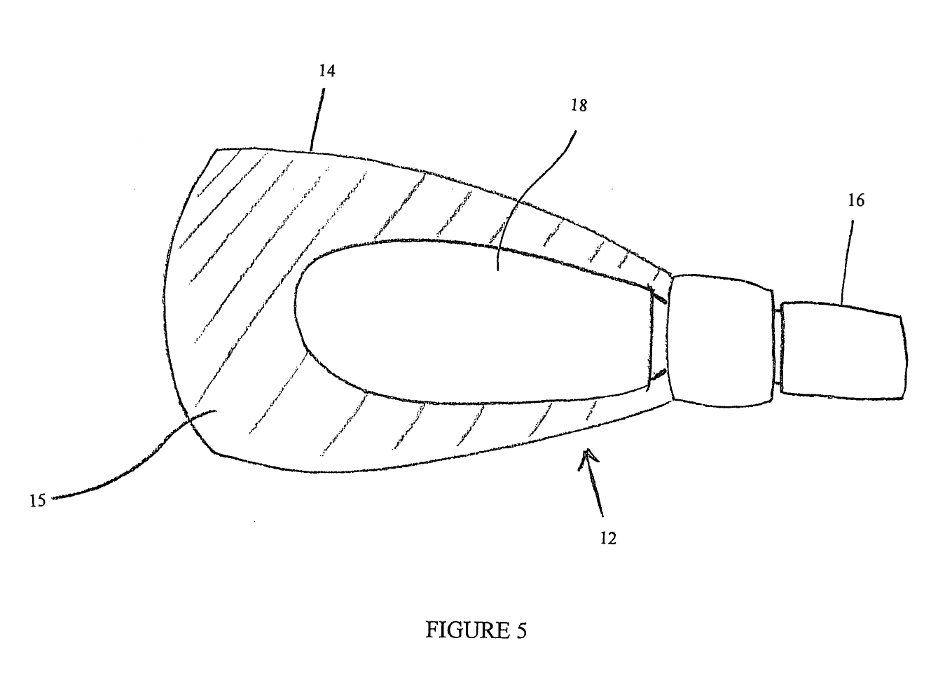

FIG. 5 shows a bottom view of the lamp 12 having a socket by which the lamp 12 is connected to the flexible coil 30. As shown in FIG. 5, the lamp 12 may also include a bulb 18 in the socket 16. In example embodiments, the bulb 18 may be, but is not limited to, a screw-type metal halide bulb, or a bulb that is slide-fit into the socket 16. The bulb 18 may be specific for grow lights, such as full-spectrum daylight bulb. For photosynthesis, plants need light between 400 and 700 nm (Photosynthetically Active Radiation or PAR). Younger plants require a PAR that is the range of between 400 and 500 nm which corresponds to blue light to provide the spectrum of light essential for larger leaf mass and thicker primary stems.

The light shield 14 reflects light from the bulb 18 toward a plant and prevents excess light loss. In an embodiment, the light shield 14 may have an inner surface facing the light bulb 18 that is coated with a reflective material 15 to increase light efficiency and reduce heating of the light shield doe to proximity of the bulb 18. The reflective material may include, but is not limited to, a reflective paint or coating, or a secondary material that may reflect light and/or insulate the light shield 14.

The above detailed description describes example embodiments of the present invention. Persons skilled in the art will recognize that alternative embodiments are possible without departing from the scope and spirit of the present invention.

We claim:

1. A plant grow light, comprising:
a flexible coil;
a clip attached to a first end of the flexible coil;
a lamp attached to a second end of the flexible coil; and
a digital timer attached to the plant grow light that controls activation of the lamp.

2. The plant grow light of claim 1, wherein the digital timer includes a semiconductor device that controls a lighting cycle of the plant grow light.

3. The plant grow light bed of claim 2, wherein the semiconductor device includes at least one memory device that stores at least one program for calculating a clock cycle corresponding to a lighting cycle of a plurality of different plant types.

4. The plant grow light of claim 2, wherein the semiconductor device controls a lighting cycle for a plurality of different plant types.

5. The plant grow light of claim 1, wherein an output of the semiconductor device is operably connected to the lamp.

6. The plant grow light bed of claim 2, wherein the semiconductor device includes at least one memory device that stores a program for calculating a clock cycle corresponding to a lighting cycle of the plant grow light.

7. The plant grow light of claim 1, wherein the digital timer is attached to the flexible coil.

8. The plant grow light of claim 1, further comprising:
a socket and the lamp is attached to the flexible coil via the socket.

9. The plant grow light of claim 1, wherein the lamp includes at least one light bulb.

10. The plant grow light of claim 1, wherein the lamp includes a light shield disposed over a surface of the at least one bulb.

11. The plant grow light of claim 1, wherein the light shield has a reflective material on an inner surface to reflect light from the at least one bulb away from the light shield.

12. The plant grow light of claim 1, wherein the flexible coil includes a flexible core.

13. The plant grow light of claim 9, wherein the flexible core is covered by an outer layer.
